(19) United States
(12) Patent Application Publication
(10) Pub. No.: US 2026/0021824 A1
(43) Pub. Date: Jan. 22, 2026

(54) RISK PRESENTATION APPARATUS AND, RISK PRESENTATION METHOD

(71) Applicant: HONDA MOTOR CO., LTD., Tokyo (JP)

(72) Inventors: Srinivasa Divakar BHAT, Wako-shi (JP); Prateek GARG, Wako-shi (JP); Mudit SONI, Wako-shi (JP); Tarun SATHESH, Wako-shi (JP); Surbhi AGRAWAL, Wako-shi (JP); Akira KANEHARA, Wako-shi (JP); Masamitsu TSUCHIYA, Wako-shi (JP); Ryuji IWASHITA, Wako-shi (JP)

(73) Assignee: HONDA MOTOR CO., LTD., Tokyo (JP)

(21) Appl. No.: 19/341,043

(22) Filed: Sep. 26, 2025

Related U.S. Application Data
(63) Continuation of application No. PCT/JP2023/013628, filed on Mar. 31, 2023.

(51) Int. Cl. B60W 50/14; G06F 3/04817; G06V 20/58

(52) U.S. Cl. CPC B60W 50/14; G06F 3/04817; G06V 20/58; B60W 2050/146

(57) ABSTRACT

A risk presentation apparatus presents risk information to an occupant of a vehicle. The risk presentation apparatus identifies a risk target present in surroundings of the vehicle and presents, to a user, a risk information image including a plurality of sectors respectively corresponding to a plurality of directions with respect to the vehicle. In a case where a risk target is present in a direction corresponding to an individual sector of the plurality of sectors, the apparatus highlights the individual sector, and includes an icon representing a type of the risk target in the individual sector. In a case where a plurality of risk targets of an identical type are present in the direction corresponding to the individual sector, the apparatus includes only one icon for the plurality of risk targets in the individual sector.

### CROSS-REFERENCE TO RELATED APPLICATION(S)

This application is a continuation of International Patent Application No. PCT/JP2023/013628 filed on Mar. 31, 2023, the entire disclosure of which is incorporated herein by reference.

### BACKGROUND OF THE INVENTION

### Field of the Invention

The present invention relates to a risk presentation apparatus and a risk presentation method.

### Description of the Related Art

There is a known technique for detecting a risk target in the surroundings of a vehicle and presenting information indicating the risk target to an occupant of the vehicle. In the technique described in Japanese Patent Laid-Open No. 2015-127160, in order to display a target object located in the surroundings of the self-vehicle in a highlighted manner, the target object is displayed in a mode of surrounding the target object with a display frame that is associated with the target object. After recognizing the risk target, the occupant of the vehicle takes action to handle the risk target as necessary. If the occupant of the vehicle is able to easily recognize the risk target, safety against the risk target is improved.

### SUMMARY OF THE INVENTION

According to some aspects of the present invention, a technique for presenting risk information is provided to be easily recognizable. According to some embodiments, a risk presentation apparatus for presenting risk information to an occupant of a vehicle, the risk presentation apparatus comprising: an identification unit configured to identify a risk target present in surroundings of the vehicle; and a presentation unit configured to present, to a user, a risk information image including a plurality of sectors respectively corresponding to a plurality of directions with respect to the vehicle, wherein in a case where a risk target is present in a direction corresponding to an individual sector of the plurality of sectors, the presentation unit highlights the individual sector, and includes an icon representing a type of the risk target in the individual sector, and in a case where a plurality of risk targets of an identical type are present in the direction corresponding to the individual sector, the presentation unit includes only one icon for the plurality of risk targets in the individual sector is provided.

Further features of the present invention will become apparent from the following description of exemplary embodiments with reference to the attached drawings.

### BRIEF DESCRIPTION OF THE DRAWINGS

FIG. 1 is a block diagram for describing a configuration example of a vehicle according to some embodiments.

FIG. 2 is a block diagram illustrating a hardware configuration example of a drive recorder according to some embodiments.

FIG. 3 is a flowchart for describing an operation example of the drive recorder according to some embodiments.

FIG. 4 is a schematic view illustrating an example of a risk display image according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

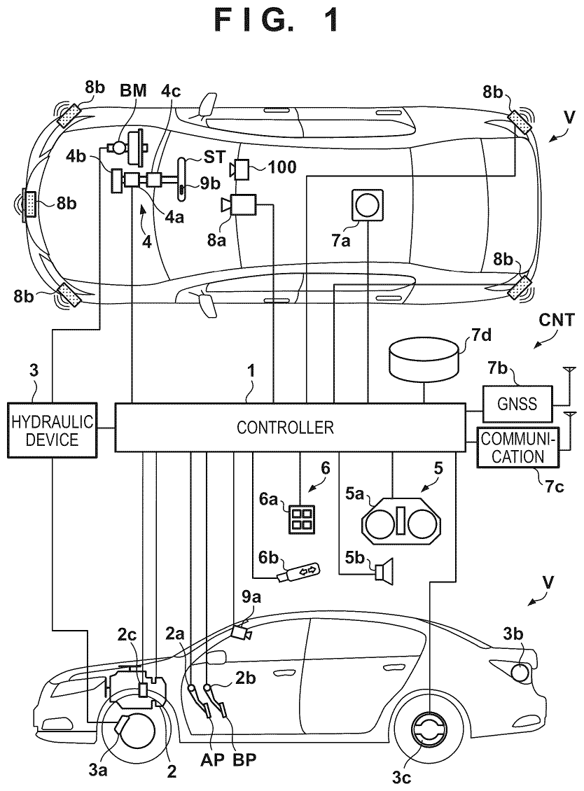

Referring to FIG. 1, a configuration example of a vehicle V according to some embodiments will be described. FIG. 1 is a block diagram of a control device CNT, and is a schematic diagram of a vehicle V as its application example. In FIG. 1, an outline of the vehicle V is illustrated in a plan view and a side view. The vehicle V in the present embodiment is, as an example, a sedan-type four-wheeled passenger vehicle, and can be, for example, a parallel hybrid vehicle. The vehicle Vis not limited to the four-wheeled passenger vehicle, and may be a straddle type vehicle (a two-wheeled or three-wheeled motorcycle) or a large-sized vehicle such as a truck or a bus.

The control device CNT includes a controller 1 which is an electronic circuit that conducts control of the vehicle V including driving assistance of the vehicle V. The controller 1 includes a plurality of electronic control units (ECUs). For example, an ECU is provided for every function of the control device CNT. Each ECU includes a processor represented by a central processing unit (CPU), a storage device such as a semiconductor memory, an interface with an external device, and the like. The storage device stores a program to be executed by the processor, data used for processing on the processor, and the like. The interface includes an input and output interface, and a communication interface. Each ECU may include a plurality of processors, a plurality of storage devices, and a plurality of interfaces. A program to be stored in the storage device may be installed in the control device CNT using a storage medium such as a CD-ROM so as to be stored in the storage device. Additionally or alternatively, the program to be stored in the storage device may be downloaded from an external server on wireless communication.

The controller 1 controls driving (acceleration) of the vehicle V by controlling a power unit (power plant) 2. The power unit 2 is a traveling drive unit that outputs driving force for rotating driving wheels of the vehicle V, and can include an internal combustion engine, a motor, and an automatic transmission. The motor can be used as a drive source for accelerating the vehicle V, and can also be used as a generator at the time of deceleration or the like (regenerative braking).

In the present embodiment, the controller 1 controls outputs of the internal combustion engine and the motor, or switches a gear ratio of the automatic transmission in accordance with a driver's driving operation detected by an operation detection sensor 2a provided in an accelerator pedal AP and an operation detection sensor 2b provided in a brake pedal BP, a vehicle speed of the vehicle V detected by a rotation speed sensor 2c, and the like. The automatic transmission is provided with the rotation speed sensor 2c, which detects the rotation speed of an output shaft of the automatic transmission as a sensor for detecting a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A driver's braking operation on the brake pedal BP is converted into hydraulic pressure in a brake master cylinder BM, and is transmitted to the hydraulic device 3. The hydraulic device 3 is an actuator capable of controlling a hydraulic pressure of a hydraulic oil supplied to a brake device 3a (for example, a disc brake device) provided on each of the four wheels, based on the hydraulic pressure transmitted from the brake master cylinder BM.

The controller 1 is capable of controlling the braking of the vehicle V, by controlling the driving of an electromagnetic valve or the like included in the hydraulic device 3. In addition, the controller 1 is also capable of configuring an electric servo brake system, by controlling the distribution of the braking force by the brake device 3a and the braking force by the regenerative braking of the motor included in the power unit 2. The controller 1 may turn on a brake lamp 3b at the time of braking.

The controller 1 controls the steering of the vehicle V by controlling an electric power steering device 4. The electric power steering device 4 includes a mechanism for steering front wheels in response to a driver's driving operation (steering operation) on a steering wheel ST. The electric power steering device 4 includes a drive unit 4a, which exerts driving force (referred to as steering assist torque, in some cases) for assisting in the steering operation or automatic steering of the front wheels of the vehicle V. The drive unit 4a includes a motor as a drive source. In addition, the electric power steering device 4 further includes a steering angle sensor 4b, which detects a steering angle, and a torque sensor 4c, which detects steering torque (also, referred to as steering load torque to be distinguished from steering assist torque) applied by the driver.

The controller 1 controls an electric parking brake device 3c provided in each of the rear wheels of the vehicle V. The electric parking brake device 3c includes a mechanism for locking the rear wheels. The controller 1 is capable of controlling locking and unlocking of the rear wheels by the electric parking brake device 3c.

The controller 1 controls an information output device 5, which notifies the inside of the vehicle of information. The information output device 5 includes, for example, a display device 5a, which notifies the driver of information by images, and/or a sound output device 5b, which notifies the driver of information by sound. Examples of the display device 5a include a display device provided in an instrument panel, and a display device provided in the steering wheel ST. In addition, the display device 5a may include a head-up display. The information output device 5 may notify an occupant of information using vibration or light.

The controller 1 receives an instruction input from the occupant (for example, the driver) via an input device 6. The input device 6 is disposed at a position in which the driver is able to operate, and includes, for example, a switch group 6a for the driver to give an instruction to the vehicle V, and/or a blinker lever 6b to activate a direction indicator (blinker).

The controller 1 recognizes and determines a current location and a course (an attitude) of the vehicle V. In the present embodiment, the vehicle V includes a gyro sensor 7a, a global navigation satellite system (GNSS) sensor 7b, and a communication device 7c. The gyro sensor 7a detects a rotational motion (yaw rate) of the vehicle V. The GNSS sensor 7b detects the current location of the vehicle V. In addition, the communication device 7c performs wireless communication with a server that provides map information and traffic information, and acquires these pieces of information. In the present embodiment, the controller 1 determines the course of the vehicle V, based on detection results of the gyro sensor 7a and the GNSS sensor 7b, also sequentially acquires map information about the course from the server via the communication device 7c, and stores the map information in a database 7d (a storage device). The vehicle V may also include another sensor for detecting a state of the vehicle V, such as an acceleration sensor for detecting acceleration of the vehicle V.

The controller 1 performs the driving assistance of the vehicle V, based on detection results of various detection units provided in the vehicle V. The vehicle V includes a plurality of surroundings detection units 8a and 8b, each of which is an external sensor for detecting the outside (a surrounding situation) of the vehicle V, and a plurality of in-vehicle detection units 9a and 9b, each of which is an in-vehicle sensor for detecting a state inside the vehicle (the states of occupants, particularly, the driver). The controller 1 is capable of grasping the surrounding situations of the vehicle V, based on the detection results of the surroundings detection units 8a and 8b, and then performing the driving assistance of the vehicle V in accordance with the surrounding situations. In addition, the controller 1 is capable of determining whether the driver is performing a predetermined operation obligation of the driver imposed when performing the driving assistance, based on the detection results of the in-vehicle detection units 9a to 9b.

The surroundings detection unit 8a is an imaging device (hereinafter, referred to as a front camera 8a, in some cases) that captures an image ahead of the vehicle V, and is attached to a vehicle interior of the windshield at a front part of the roof of the vehicle V, for example. The imaging device captures an image of a subject to generate an image of the subject. The controller 1 analyzes the image that has been captured by the front camera 8a, and is capable of extracting a contour of a target object or a lane marking (such as a white line) of a lane on a road.

The surroundings detection unit 8b is a millimeter wave radar (hereinafter, referred to as a radar 8b, in some cases), detects a target object in the surroundings of the vehicle V using radio waves, and detects (measures) a distance to the target object and a direction (azimuth) of the target object with respect to the vehicle V. In the example illustrated in FIG. 1, five radars 8b are provided, one at the center of the front portion of the vehicle V, one at each of the left and right corner portions of the front portion, and one at each of the left and right corner portions of the rear portion.

The surroundings detection units provided in the vehicle V are not limited to the above configuration. The number of cameras and the number of radars may be changed. A light detection and ranging (LiDAR) for detecting a target object in the surroundings of the vehicle V may be provided.

The in-vehicle detection unit 9a is an imaging device (hereinafter, referred to as an in-vehicle camera 9a, in some cases) that captures an image of the inside of the vehicle, and is attached to the vehicle interior at the front part of the roof of the vehicle V, for example. In the present embodiment, the in-vehicle camera 9a is a driver monitor camera that captures an image of the driver (for example, driver's eye and face). The controller 1 analyzes the image (the image of the driver's face) that has been captured by the in-vehicle camera 9a, and is capable of determining a driver's line of sight and a direction of a driver's face.

The in-vehicle detection unit 9b is a grip sensor (hereinafter, referred to as a grip sensor 9b, in some cases) for detecting the driver gripping the steering wheel ST, and is provided on, for example, at least a part of the steering wheel ST. As the in-vehicle detection unit, a torque sensor 4c, which detects the steering torque of the driver, may be used.

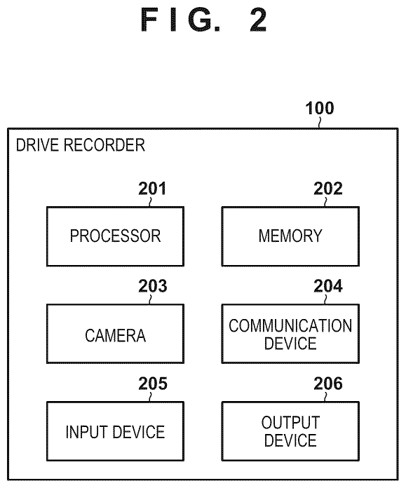

A drive recorder 100 is attached to the vehicle V. The drive recorder 100 records an image in the surroundings of the vehicle V generated by a camera 203 (FIG. 2) of the drive recorder 100. The drive recorder 100 is attached to, for example, the vehicle interior of the windshield at the front part of the roof of the vehicle V. The installed position (in particular, a position in the vehicle width direction) of the drive recorder 100 may vary depending on the type of the vehicle V or the user's preference. In some embodiments, the drive recorder 100 analyzes the image of the surroundings of the vehicle V, identifies a risk target present in the surroundings of the vehicle V, and presents a risk information image indicating the risk target to an occupant (for example, the driver) of the vehicle. In the following description, an occupant of the vehicle V will be simply referred to as the occupant.

Examples of the driving assistance of the vehicle V provided for the driver include acceleration or deceleration assistance, lane keeping assistance, and lane change assistance. The acceleration or deceleration assistance corresponds to drive assistance (adaptive cruise control (ACC)) in which the controller 1 automatically controls acceleration or deceleration of the vehicle V within a predetermined speed range by automatically controlling both the power unit 2 and the hydraulic device 3, based on the detection results of the surroundings detection units 8a and 8b and the map information. In the ACC, when there is a preceding vehicle, the acceleration or deceleration of the vehicle V is enabled so as to maintain an inter-vehicle distance from the preceding vehicle. The ACC reduces an operation load of the driver in the acceleration or deceleration operation (the operation on an accelerator pedal AP or a brake pedal BP).

The lane keeping assistance corresponds to driving assistance (lane keeping assist system (LKAS)) in which the controller 1 automatically controls the electric power steering device 4, based on the detection results of the surroundings detection units 8a and 8b and the map information so that the vehicle V keeps traveling within the lane. The LKAS reduces an operation load of the driver in a steering operation (an operation on the steering wheel ST) while the vehicle Vis advancing straight.

The lane change assistance corresponds to driving assistance (auto lane changing (ALC) or active lane change assist (ALCA)) in which the controller 1 automatically controls the power unit 2, the hydraulic device 3, and the electric power steering device 4, based on the detection results of the surroundings detection units 8a and 8b and the map information to change the traveling lane of the vehicle V to an adjacent lane. The ALC corresponds to the lane change assistance based on a system request, whereas ALCA corresponds to the lane change assistance based on a passenger's request. Examples of the system request include a case where a navigation system of giving a route guidance of the vehicle V to a destination requests a lane change of the vehicle V, and a case where the vehicle overtakes a preceding vehicle regardless of presence or absence of the route guidance. When making an occupant's request, the driver operates the input device (for example, the blinker lever 6b), and gives an instruction to change lanes. Both the ALC and the ALCA reduce an operation load of the driver in the acceleration or deceleration operation and the steering operation on the vehicle V, when changing lanes.

Other examples of the drive assistance control may include collision reduction braking that assists collision avoidance with a target object (for example, a pedestrian, another vehicle, or an obstacle) on a road, by controlling the hydraulic device 3, an ABS function, traction control, and/or posture control of the vehicle V.

A hardware configuration example of the drive recorder 100 will be described with reference to FIG. 2. The drive recorder 100 may include, for example, the components illustrated in FIG. 2. The drive recorder 100 may not necessarily include some of the components illustrated in FIG. 2, or may include any component that is not included in FIG. 2. For example, the drive recorder 100 may further include a global navigation satellite system (GNSS) sensor, or an accelerometer.

A processor 201 controls the overall operation of the drive recorder 100. The processor 201 may be configured with, for example, a central processing unit (CPU). The processor 201 may be a single processor or a group of a plurality of processors.

A memory 202 stores programs and data for use in the operation of the drive recorder 100. The memory 202 may record an image (in particular, a moving image) in the surroundings of the vehicle V generated by the camera 203. The memory 202 may be configured with, for example, a read-only memory (ROM) or a random access memory (RAM). The memory 202 may be a single memory or a group of a plurality of memories.

The camera 203 is a device for capturing an image of the surroundings of the vehicle V. When the camera 203 captures an image of the surroundings of the vehicle V, the image of the surroundings of the vehicle Vis generated. The camera 203 may be a camera (a so-called 360-degree camera) capable of capturing an image of the surroundings of the vehicle V at 360 degrees on a horizontal plane. Alternatively, the camera 203 may be capable of capturing an image of a specific range (for example, a range of 120 degrees ahead of the vehicle V with the vehicle length direction as its center) in the surroundings of the vehicle V on a horizontal plane. The drive recorder 100 may further include a camera for capturing an image of a rearward side of the vehicle V.

A communication device 204 is a device that performs communication with a device different from the drive recorder 100. For example, the communication device 204 may be capable of communicating with the communication device 7c of the vehicle V. Alternatively or additionally, the communication device 204 may be capable of communicating with a portable device (for example, a smartphone) carried by the user. The communication by the communication device 204 may be wireless communication or wired communication. For example, the communication by the communication device 204 may be short-range wireless communication such as Bluetooth (registered trademark).

An input device 205 is a device for receiving an instruction from the user of the drive recorder 100. The input device 205 may be configured with a physical button, a toggle switch, a touch panel, or any combination of them. The instruction from the user to the drive recorder 100 may be acquired from another device via the communication device 204, in addition to or instead of the instruction via the input device 205.

An output device 206 is a device for outputting information to the user. The output device 206 may be configured with a display device such as a liquid crystal display, an acoustic device such as a speaker, a lamp, an indicator, or any combination of them. The output of the information to the user may be performed in another device via the communication device 204, in addition to or instead of the output via the output device 206.

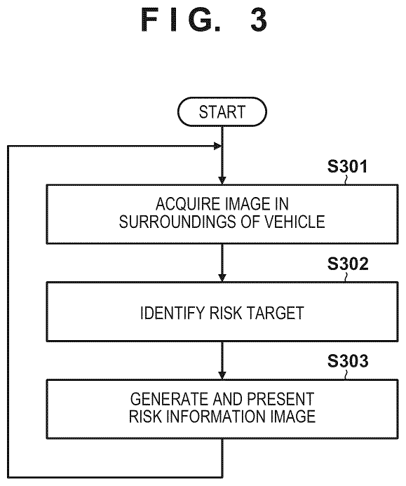

An operation example of the drive recorder 100 will be described with reference to FIG. 3. In FIG. 3, an operation performed by the drive recorder 100 for presenting the risk information to the occupant will be described. The drive recorder 100 operating in this manner functions as a risk presentation apparatus. Each step in the method in FIG. 3 may be performed by the processor 201 executing a program stored in the memory 202. Alternatively, some or all of the steps in the method of FIG. 3 may be performed by a dedicated integrated circuit, such as an application specific integrated circuit (ASIC). The method of FIG. 3 may be started in response to the drive recorder 100 being powered on, or may be started in response to the user instructing to start presenting the risk information, or may be started in another manner. The method of FIG. 3 may be performed while the vehicle Vis traveling in accordance with manual driving, but may be performed while the vehicle V is traveling in accordance with automated driving.

In S301, the processor 201 acquires an image in the surroundings of the vehicle V generated by the camera 203. The camera 203 repeats capturing an image in the surroundings of the vehicle V, while the method in FIG. 3 is being performed. The processor 201 may store the image ahead of the vehicle V in the memory 202 in order to record the image.

In S302, the processor 201 analyzes the image acquired in S301, and identifies a risk target present in the surroundings of the vehicle V. The risk target may be a traffic participant including a pedestrian and a bicycle rider. Furthermore, the traffic participant identified as the risk target may include another vehicle, such as a two-wheeled vehicle or a four-wheeled vehicle. The processor 201 may identify all traffic participants included in the image in the surroundings of the vehicle V as the risk targets, or may identify a traffic participant that satisfies a specific condition among these traffic participants, as the risk target. For example, the processor 201 may identify a traffic participant located on the course of the vehicle V or in its vicinity or a traffic participant moving toward the course of the vehicle V or toward its vicinity, as the risk target. What target object is to be the risk target may be set beforehand by the manufacturer of the drive recorder 100, and may be stored in the memory 202 as data. In addition, the user of the drive recorder 100 may be able to change this setting.

In S302, the processor 201 may identify, for each of the risk targets that have been identified, a direction of the risk target with respect to the vehicle V and a type of the risk target. The type of risk target may be identified as one of a plurality of types set beforehand (examples including “pedestrian”, “bicycle rider”, “two-wheeled vehicle”, “four-wheeled vehicle”, “others”). Furthermore, the processor 201 may identify, for each of the risk targets that have been identified, a distance from the vehicle V to the risk target.

In S303, the processor 201 generates an image (hereinafter, risk information image) indicating the risk target identified in S302, and presents the risk information image to the user. The presentation of the risk information image to the user may be performed in any manner. For example, the processor 201 may display the risk information image on the output device 206 (for example, a display). Alternatively or additionally, the processor 201 may transmit the risk information image to another apparatus via the communication device 204, and the risk information image may be displayed on a display of such another apparatus. For example, the processor 201 may transmit the risk information image to the vehicle V, and the risk information image may be displayed on the display device 5a of the vehicle V. The processor 201 may transmit the risk information image to a mobile device (for example, a smartphone) of the occupant, and the risk information image may be displayed on a display of the mobile device.

The processor 201 repeats the above-described S301 to S303 to update the risk information image and indicate the latest risk target. For example, the processor 201 may repeat the above-described S301 to S303 at a specific cycle (for example, a cycle of 10 ms, a cycle of 100 ms, or the like.).

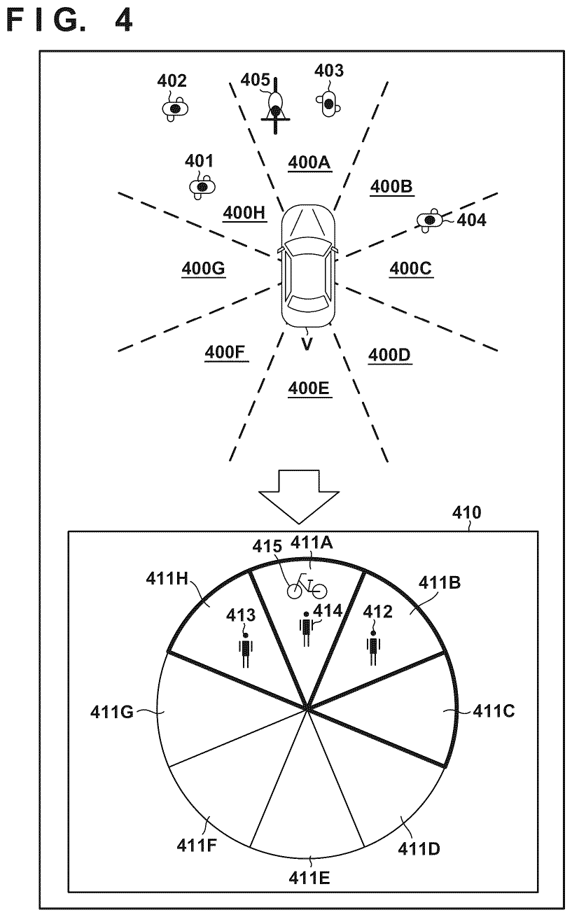

A specific example of a risk information image 410, which is generated by the processor 201, will be described with reference to FIG. 4. The upper part of FIG. 4 indicates the risk targets that have been identified by the processor 201 performing S301 and S302 at a certain time. In the example of FIG. 4, four pedestrians 401 to 404 and one bicycle rider 405 are identified as the risk targets. For the sake of description, the surroundings of the vehicle V are divided into eight directions 400A to 400H on a horizontal plane (divided into eight equal parts in the example of FIG. 4). The direction 400A represents a forward side of the vehicle V. The direction 400B represents a right forward side of the vehicle V. The direction 400C represents a right side of the vehicle V. The direction 400D represents a right rearward side of the vehicle V. The direction 400E represents a rearward side of the vehicle V. The direction 400F represents a left rearward side of the vehicle V. The direction 400G represents a left side of the vehicle V. The direction 400H represents a left forward side of the vehicle V.

In the example of FIG. 4, the pedestrians 401 and 402 are present in the direction 400H with respect to the vehicle. The pedestrian 403 and the bicycle rider 405 are present in the direction 400A with respect to the vehicle. The pedestrian 404 is present on the boundary between the direction 400B and the direction 400C with respect to the vehicle.

The lower part of FIG. 4 illustrates the risk information image 410 to be presented to the occupant. The risk information image 410 includes a plurality of sectors 411A to 411H, which respectively correspond to the plurality of directions 400A to 400H with respect to the vehicle V. Each of the sectors 411A to 411H has a fan shape, and has a center angle of 45 degrees. The centers of the plurality of sectors 411A to 411H coincide with one another, and the insides of the plurality of sectors 411A to 411H do not overlap with one another. Therefore, a disk shape is made up of the plurality of sectors 411A to 411H. The sector 411A is located on an upper side with respect to the center of the disk. The sector 411B is located on an upper right side with respect to the center of the disk. The sector 411C is located on a right side with respect to the center of the disk. The sector 411D is located on a lower right side with respect to the center of the disk. The sector 411E is located on a lower side with respect to the center of the disk. The sector 411F is located on a lower left side with respect to the center of the disk. The sector 411G is located on a left side with respect to the center of the disk. The sector 411H is located on an upper left side with respect to the center of the disk. The plurality of sectors 411A to 411H respectively correspond to the directions marked with identical alphabets, among the plurality of directions 400A to 400H. For example, the sector 411A corresponds to the direction 400A.

When a risk target is present in the direction corresponding to an individual sector among the plurality of sectors 411A to 411H, the processor 201 highlights such an individual sector. For example, the pedestrian 403 and the bicycle rider 405 are present in the direction 400A, which corresponds to the sector 411A. Thus, the processor 201 highlights the sector 411A. In the example of FIG. 4, the sector 411A is highlighted by thickening the outline of the sector 411A. Alternatively, the sector 411A may be highlighted in any other manner. For example, the sector 411A may be displayed in a highlighted manner in a color different from the background color, or may be displayed in an enlarged manner. The pedestrians 401 and 402 are present in the direction 400H, which corresponds to the sector 411H. Thus, the processor 201 also highlights the sector 411H.

When a risk target is present between two directions corresponding two sectors adjacent to each other, the processor 201 may highlight both of these two sectors. For example, the pedestrian 404 is present between two directions (the directions 400B and 400C) corresponding to two sectors (the sectors 411B and 411C) adjacent to each other. Therefore, the processor 201 may highlight both the sector 411B and the sector 411C.

In addition to highlighting the sectors as described above, when a risk target is present in a direction corresponding to an individual sector among the plurality of sectors 411A to 411H, the processor 201 includes an icon representing the type of the risk target in such an individual sector. For example, the pedestrian 403 and the bicycle rider 405 are present in the direction 400A, which corresponds to the sector 411A. Thus, the processor 201 includes a pedestrian icon 414 representing the pedestrian and a bicycle icon 415 representing the bicycle rider in the sector 411A. In this manner, when there are a plurality of different types of risk targets in the direction corresponding to the individual sector, the processor 201 includes the icon representing each type in the individual sector for each of the plurality of types. This enables the occupant to easily recognize the direction in which the risk target is present and the type of the risk target.

When a plurality of risk targets of an identical type are present in the direction corresponding to the individual sector, the processor 201 may include only one icon for the plurality of risk targets in the individual sector. For example, two pedestrians 401 and 402 are present in the direction 400H corresponding to the sector 411H. Thus, the processor 201 includes only one pedestrian icon 413 representing the pedestrian in the sector 411H. This enables improvement in the visibility of the icon, as compared with a case where a plurality of the identical icons are displayed in one sector.

When a risk target is present in two directions corresponding to the two sectors adjacent to each other, the processor 201 may include an icon representing the type of risk target in only one of these two sectors. For example, the pedestrian 404 is present between two directions (the directions 400B and 400C) corresponding to two sectors (the sectors 411B and 411C) adjacent to each other. Thus, the processor 201 includes a pedestrian icon 412 in only one of the sector 411B and the sector 411C (in the example of FIG. 4, the sector 411B). Accordingly, it becomes possible to suppress the occupant's misunderstanding that different pedestrians are respectively present in the direction 400B corresponding to the sector 411B and the direction 400C corresponding to the sector 411C. In addition, the visibility of the icon is improved by not displaying the icon on the boundary between the two sectors. The processor 201 may include the icon in either one of the two sectors adjacent to each other. In the example of FIG. 4, in a case where another pedestrian different from the pedestrian 404 is present in the direction 400C, the processor 201 may include a pedestrian icon for representing such another pedestrian in the sector 411C.

In a case where two icons representing two different types of risk targets are included in a sector, such as the sector 411A, the processor 201 may highlight the icon representing the type of a risk target having a higher risk than the icon representing the type of a risk target having a lower risk, or may not necessarily highlight the icon. For example, in the example of FIG. 4, it is assumed that the risk of the pedestrian 403 is higher than the risk of the bicycle rider 405. In this case, the processor 201 may highlight the pedestrian icon 414 more than the bicycle icon 415. For example, the processor 201 may blink the pedestrian icon 414, and may light the bicycle icon 415. Alternatively, the processor 201 may display the pedestrian icon 414 to be larger than the bicycle icon 415. The processor 201 may determine the level of risk, based on, for example, a distance between the vehicle V and the risk target, a moving direction of the risk target, or the like.

The icon representing the type of risk target may be displayed at a fixed position in the sector. Alternatively, the icon representing the type of the risk target may be displayed at a position in the sector corresponding to the location of the risk target with respect to the vehicle V. For example, the distance of the icon from the center of the disk constituted of the plurality of sectors 411A to 411H may correspond to the distance of the risk target from the vehicle V. In addition, the direction of the icon with respect to the center of the disk constituted of the plurality of sectors 411A to 411H may correspond to the direction of the risk target with respect to the vehicle V. In this manner, in a case where the position of the icon corresponds to the location of the risk target, the processor 201 moves the icon in the individual sector in accordance with a movement of the risk target present in the direction corresponding to the individual sector.

Like the sector 411H, when one icon (the pedestrian icon 413) is displayed for a plurality of risk targets of the identical type (the pedestrians 401 and 402), the position of the icon may correspond to the location of the risk target having the highest risk of the plurality of risk targets. For example, in a case where the risk of the pedestrian 401 is higher than that of the pedestrian 402, the position of the pedestrian icon 413 in the sector 411H may correspond to the location of the pedestrian 401 with respect to the vehicle V. Accordingly, when a plurality of risk targets of the identical type are present in the direction corresponding to the individual sector, the processor 201 moves the icon in the individual sector in accordance with the movement of the risk target having the highest risk of the plurality of risk targets. This enables the occupant to recognize the movement of the risk target on the risk information image 410.

In the above-described embodiment, the processor 201 identifies the risk target all over 360 degrees in the surroundings of the vehicle V on a horizontal plane. Alternatively, the processor 201 may identify the risk target in the surroundings of the vehicle V over a partial range on the horizontal plane in accordance with the image-capturing range of the camera 203. For example, the processor 201 may identify a risk target ahead of the vehicle V on the horizontal plane. In this case, the risk information image 410 may include, for example, the sectors 411A, 411B, and 411H, and may not necessarily include the sectors 411C to 411G.

In the above-described embodiment, the drive recorder 100 performs the operation of FIG. 3. Alternatively, the control device CNT of the vehicle V may perform the operation of FIG. 3. In this case, the control device CNT functions as the risk presentation apparatus. In S301, the control device CNT may use an image of the surroundings of the vehicle V that has been captured by the surroundings detection unit 8a. In S303, the control device CNT may present the risk information image on the display device 5a of the vehicle V.

### SUMMARY OF EMBODIMENTS

[Item 1] A risk presentation apparatus (CNT, 100) for presenting risk information to an occupant of a vehicle (V), the risk presentation apparatus comprising:
an identification unit (1, 201) configured to identify a risk target (401-405) present in surroundings of the vehicle; and
a presentation unit (1, 201) configured to present, to a user, a risk information image (410) including a plurality of sectors (411A-411H) respectively corresponding to a plurality of directions (400A-400H) with respect to the vehicle, wherein
   in a case where a risk target is present in a direction corresponding to an individual sector of the plurality of sectors, the presentation unit highlights the individual sector, and includes an icon (412-415) representing a type of the risk target in the individual sector, and
   in a case where a plurality of risk targets (401, 402) of an identical type are present in the direction corresponding to the individual sector, the presentation unit includes only one icon (413) for the plurality of risk targets in the individual sector.

According to this item, it becomes possible to present the risk information to be easily recognizable.
[Item 2] The risk presentation apparatus according to Item 1, wherein the presentation unit moves the icon in the individual sector in accordance with a movement of the risk target present in the direction corresponding to the individual sector.

According to this item, it becomes possible to present the risk information so that the movement of the risk target is recognizable.
[Item 3] The risk presentation apparatus according to Item 2, wherein in a case where the plurality of risk targets of the identical type are present in the direction corresponding to the individual sector, the presentation unit moves the icon in the individual sector in accordance with the movement of a risk target having a highest risk of the plurality of risk targets.

According to this item, it becomes possible to present the risk information image so that the movement of the risk target having a high risk is recognizable.
[Item 4] The risk presentation apparatus according to any one of Items 1-3, wherein in a case where risk targets of different types are present in the direction corresponding to the individual sector, the presentation unit includes an icon representing each type in the individual sector for each of the plurality of types.

According to this item, it becomes possible to present the risk information so that the type of the risk target is easily recognizable.
[Item 5] The risk presentation apparatus according to Item 4, wherein out of two risk targets of different types, the presentation unit highlights an icon representing a type of a risk target having a higher risk more than an icon representing a type of a risk target having a lower risk.

According to this item, it becomes possible to present the risk information so that the type of the risk target having a high risk is easily recognizable.
[Item 6] The risk presentation apparatus according to any one of Items 1-5, wherein in a case where a risk target is present between two directions respectively corresponding to two sectors adjacent (400B, 400C) to each other, the presentation unit highlights the two sectors, and includes an icon (412) representing a type of the risk target in only one of the two sectors.

According to this item, it becomes possible to present the risk information so that the type of the risk target having a high risk is easily recognizable.
[Item 7] A non-transitory computer readable storage medium storing a program for causing a computer to function as the risk presentation apparatus according to any one of Items 1-6.

According to this item, the above-described items are provided in the form of a storage medium.
[Item 8] A method for presenting risk information to an occupant of a vehicle (V), the method comprising:
identifying (S302) a risk target (401-405) present in surroundings of the vehicle; and
presenting (S303), to a user, a risk information image (410) including a plurality of sectors (411A-411H) respectively corresponding to a plurality of directions (400A-400H) with respect to the vehicle, wherein
   in a case where a risk target is present in a direction corresponding to an individual sector of the plurality of sectors, the individual sector is highlighted, and an icon (412-415) representing a type of the risk target is included in the individual sector, and
   in a case where a plurality of risk targets (401, 402) of an identical type are present in a direction corresponding to the individual sector, only one icon (413) for the plurality of risk targets is included in the individual sector.

According to this item, it becomes possible to present the risk information to be easily recognizable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A risk presentation apparatus for presenting risk information to an occupant of a vehicle, the risk presentation apparatus comprising:
an identification unit configured to identify a risk target present in surroundings of the vehicle; and
a presentation unit configured to present, to a user, a risk information image including a plurality of sectors respectively corresponding to a plurality of directions with respect to the vehicle, wherein
in a case where a risk target is present in a direction corresponding to an individual sector of the plurality of sectors, the presentation unit highlights the individual sector, and includes an icon representing a type of the risk target in the individual sector, and
in a case where a plurality of risk targets of an identical type are present in the direction corresponding to the individual sector, the presentation unit includes only one icon for the plurality of risk targets in the individual sector.

2. The risk presentation apparatus according to claim 1, wherein the presentation unit moves the icon in the individual sector in accordance with a movement of the risk target present in the direction corresponding to the individual sector.

3. The risk presentation apparatus according to claim 2, wherein in a case where the plurality of risk targets of the identical type are present in the direction corresponding to the individual sector, the presentation unit moves the icon in the individual sector in accordance with the movement of a risk target having a highest risk of the plurality of risk targets.

4. The risk presentation apparatus according to claim 1, wherein in a case where risk targets of different types are present in the direction corresponding to the individual sector, the presentation unit includes an icon representing each type in the individual sector for each of the plurality of types.

5. The risk presentation apparatus according to claim 4, wherein out of two risk targets of different types, the presentation unit highlights an icon representing a type of a risk target having a higher risk more than an icon representing a type of a risk target having a lower risk.

6. The risk presentation apparatus according to claim 1, wherein in a case where a risk target is present between two directions respectively corresponding to two sectors adjacent to each other, the presentation unit highlights the two sectors, and includes an icon representing a type of the risk target in only one of the two sectors.

7. A non-transitory computer readable storage medium storing a program for causing a computer to function as the risk presentation apparatus according to claim 1.

8. A method for presenting risk information to an occupant of a vehicle, the method comprising:
identifying a risk target present in surroundings of the vehicle; and
presenting, to a user, a risk information image including a plurality of sectors respectively corresponding to a plurality of directions with respect to the vehicle, wherein
in a case where a risk target is present in a direction corresponding to an individual sector of the plurality of sectors, the individual sector is highlighted, and an icon representing a type of the risk target is included in the individual sector, and
in a case where a plurality of risk targets of an identical type are present in a direction corresponding to the individual sector, only one icon for the plurality of risk targets is included in the individual sector.
